(19) United States
(12) Patent Application Publication
(10) Pub. No.: US 2014/0333017 A1
(43) Pub. Date: Nov. 13, 2014

(54) Drop Pressure Release

(71) Applicant: Peter Azof, Tracy, CA (US)

(72) Inventor: Peter Azof, Tracy, CA (US)

(21) Appl. No.: 14/450,173

(22) Filed: Aug. 1, 2014

(51) Int. Cl. B65G 69/00; F16M 13/02

(52) U.S. Cl. CPC B65G 69/001; F16M 13/02
USPC 267/140; 248/251; 267/139

(57) ABSTRACT

Disclosed is an apparatus for protecting a dock comprising a Rod Receiver (100) having a at least one Rod Receptacle (115) with each of the at least one Rod Receptacle (115) having a Receptacle Slot (125) having a height ‘d_{H}’ with a Rod Stop Slot (130) adjacently below the Receptacle Slot (125) and having a Wall (135) with a height ‘d_{S}’ between the Rod Stop Slot (130) and a Rod Incline Rail (140), and a Rod Holder (200) having at least one Rod (215) with the at least one Rod (215) having a diameter ‘d_{R}’ which is less than the Receptacle Slot (125) height ‘d_{H}’.

### CROSS-REFERENCE TO RELATED APPLICATION

This application claims the benefit of priority of U.S. Provisional Patent Application 62/001556 filed May 21, 2014 and titled “DROP PRESSURE RELEASE,” the disclosure of which is incorporated by reference.

### BACKGROUND OF THE INVENTION

1. Field of Invention

The invention relates generally to the field of devices relating to loading docks and more specifically to devices for protecting loading docks from damage as trailers are backed into the dock.

2. Description of Related Art

Docking a tractor-trailer is a difficult experience. If too far from the dock, a gap exists between the trailer floor and the dock, which can hang-up a fork lift or cause a person to trip, either of which causes property damage and injury, and even small gaps can cause eventual knee and back pain. If too close to the dock, the trailer strikes the dock causing shock damage. In addition, the trailer landing gear must be are set so the trailer has a slight down tilt away from the dock to prevent upending. When the front end of the trailer drops, the door end raises slightly up and back, and often with enough force to damage anything between the trailer and the dock.

Rubber bumpers affixed to the dock reduce damage to the dock, but like the docks they protect, rubber bumpers tend to wear out.

### SUMMARY OF THE INVENTION

Disclosed are a Rod Receiver (100) comprising a Rod Receiver Back Plate (105), with at least one Rod Receiver Side Plate (110) affixed to the Rod Receiver Back Plate (105), with at least one Rod Receptacle (115) within the Rod Receiver Side Plate (110), with a Receptacle Slot (125) having a height ‘d_{H}’ within each of the at least one Rod Receptacle (115) and located along an Outer Edge (120) of the at least one Rod Receiver Side Plate (110), with a Rod Stop Slot (130) adjacently below the Receptacle Slot (125) and having a Wall (135) with a height ‘d_{S}’ with a Rod Incline Rail (140) adjacent to the Rod Stop Slot (130) and having an incline angle (‘θ’) within each of the at least one Rod Receptacle (115), and a Rod Guide Rail (145) within each of the at least one Rod Receptacle (115) and having a shape approximating a curve between the Rod Incline Rail (140) and the Receptacle Slot (125).

Also disclosed is a Rod Holder (200) comprising a Rod Holder Back Plate (205), with at least one Rod Holder Side Plate (210) affixed to the Rod Holder Back Plate (205), at least one Rod (215) located adjacent to an Outer Edge (220) of the Rod Holder Side Plate (210) and affixed to the least one Rod Holder Side Plate (210) with each of the at least one Rod (215) having a diameter ‘d_{R}’.

Also disclosed is apparatus for protecting a dock comprising a Rod Receiver (100) having a at least one Rod Receptacle (115) with each of the at least one Rod Receptacle (115) having a Receptacle Slot (125) having a height ‘d_{H}’ with a Rod Stop Slot (130) adjacently below the Receptacle Slot (125) and having a Wall (135) with a height ‘d_{S}’ between the Rod Stop Slot (130) and a Rod Incline Rail (140), and a Rod Holder (200) having at least one Rod (215) with the at least one Rod (215) having a diameter ‘d_{R}’ which is less than the Receptacle Slot (125) height ‘d_{H}’.

In some embodiments, the incline angle (‘θ’) of the Rod Incline Rail (140) is approximately 10 to 40 degrees above horizontal.

In some embodiments, the Rod Receiver (100) further comprising a Midline Rod Shelf (605).

In some embodiments, the Rod Receiver (100) comprises a material selected from the group consisting of steel, iron, wood and plastic.

In some embodiments, each of the at least one Rod (215) has a diameter of approximately one inch.

In some embodiments, the Rod Holder (200) further comprises a Midline Rod Holder

Stabilizer (820).

In some embodiments, the Rod Holder (200) further comprises a Rod Holder Bumper (225) which comprises a material selected from the group consisting of rubber, recycled rubber, wood, plastic, steel, iron, and a composite of rubber and plastic.

In some embodiments, the at least one Rod (715) is affixed to a Rod Holder Midline Plate (710).

In some embodiments, the Rod Holder Bumper (225) may be recycled rubber with a thickness of approximately one and half inches.

### BRIEF DESCRIPTION OF THE DRAWINGS

FIG. 1 shows an exemplary Rod Receiver (100) of the DROP PRESSURE RELEASE.

FIG. 2 shows an inside view of an exemplary Rod Holder (200) of the DROP PRESSURE RELEASE.

FIG. 3 shows a side view of the exemplary Rod Receiver (100) mounted on a dock “D”, with the exemplary Rod Holder (200) aligned next to it, with arrows indicating how a Rod Holder (200) is set for placement within a Rod Receiver (100).

FIG. 4 shows a side view of the exemplary Rod Receiver (100) mounted on a dock “D”, with the Rod Holder (200) set onto the Rod Receiver (100), as well as a tractor-trailer or truck “T” in initial contact with the DROP PRESSURE RELEASE.

FIG. 5 shows a side view of the exemplary Rod Receiver (100) mounted on a dock “D”, with the Rod Holder (200) set within the Rod Receiver (100), as well as a tractor-trailer or truck “T” pressed against the DROP PRESSURE RELEASE after the tractor-trailer or truck “T” is parked against the DROP PRESSURE RELEASE. As shown in FIG. 5, the Rod Holder (200) has been pushed upwards and towards the dock and, giving a clear indication that the tractor-trailer or large truck properly in contact with the DROP PRESSURE RELEASE.

FIG. 6 shows an alternate embodiment of the Rod Receiver (600) of the DROP PRESSURE RELEASE.

FIG. 7 shows an alternate embodiment of the Rod Holder (700) of the DROP PRESSURE RELEASE.

FIG. 8 shows an alternate embodiment of the Rod Holder (800) of the DROP PRESSURE RELEASE.

### DETAILED DESCRIPTION OF THE INVENTION

The DROP PRESSURE RELEASE is a multiple function apparatus for protecting a dock from damage and for showing a position of a tractor-trailer or truck relative and adjacent to a dock.

In one embodiment, the DROP PRESSURE RELEASE comprises two components. A Rod Receiver (100) is attached to a dock, while a Rod Holder (200) rests within the Rod Receiver (100).

When a tractor-trailer or large truck is imminently close to contact with the Rod Holder (200) portion of the DROP PRESSURE RELEASE, the tractor-trailer or large truck should stop. When the trailer is removed from the tractor and parked on jack stands, the trailer tilts slightly downward, which pushes the door end up and back into the DROP PRESSURE RELEASE. The Rod Holder (200) moves both towards the dock and upwards, thereby preventing damage to the dock, and giving a clear indication that the tractor-trailer or large truck is in contact with the DROP PRESSURE RELEASE.

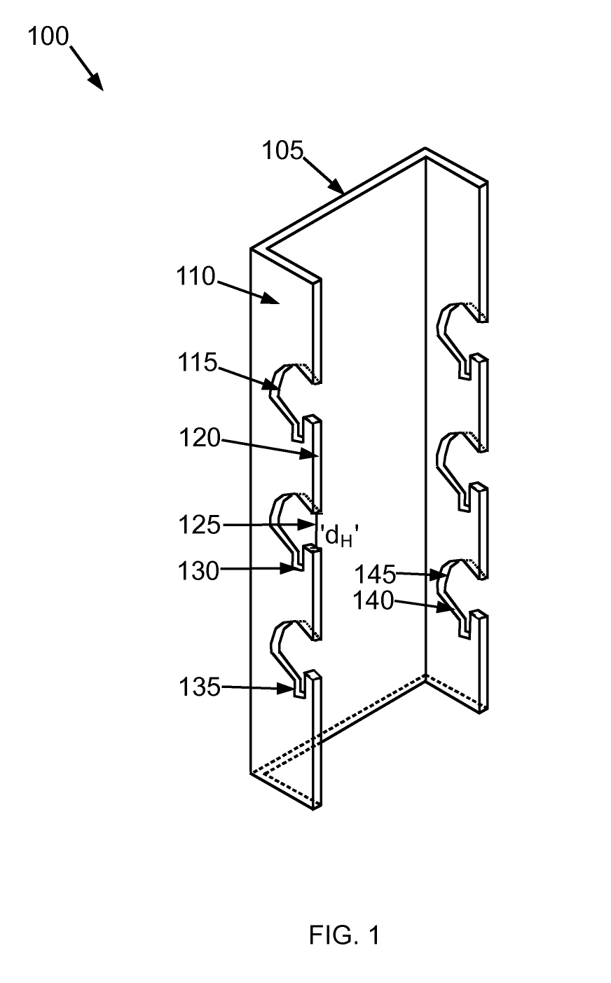

FIG. 1 shows an exemplary Rod Receiver (100) of the DROP PRESSURE RELEASE.

Shown in FIG. 1 is Rod Receiver (100), which comprises a Rod Receiver Back Plate (105), a Rod Receiver Side Plate (110), at least one Rod Receptacle (115), an Outer Edge (120) of the Rod Receiver Side Plate (110), a Receptacle Slot (125), a Rod Stop Slot (130) a Wall (135) of the Rod Stop Slot (130), a Rod Incline Rail (140), and a Rod Guide Rail (145).

The Rod Receiver (100) is affixed to a dock at a proper location for mating with the Rod Holder (200), which is discussed below.

The Rod Receiver Back Plate (105) is the support structure for the Rod Receiver (100) in that the other components of the Rod Receiver (100) are affixed directly or indirectly to the Rod Receiver Back Plate (105). In most embodiments, the Rod Receiver Back Plate (105) is affixed to the dock, although the Rod Receiver Back Plate (105) could be the dock, i.e., the dock serves the function as the support structure for the Rod Receiver (100).

The Rod Receiver Back Plate (105) is the also support structure for the DROP PRESSURE RELEASE in that the Rod Receiver Back Plate (105) receives any forces transmitted from Rod Holder (200) when a trailer contact the Rod Holder (200).

In most embodiments, the Rod Receiver Back Plate (105) would be a strong grade of steel or other metal so as to provide its function with high reliability. The Rod Receiver Back Plate (105) could be lesser grades of steel, iron, less strong metals, or even wood or plastic, with the functional exchange being the amount of force to which the Rod Receiver (100) would be subjected against the reliability and life of the Rod Receiver Back Plate (105).

The Rod Receiver Side Plate (110) is affixed to the Rod Receiver Back Plate (105) and serves as the support structure for other components of the Rod Receiver (100). The Rod Receiver Side Plate (110) may be integrated into, or affixed, including being welded, to the Rod Receiver Back Plate (105). The at least one Rod Receptacle (115), the Outer Edge (120), the Receptacle Slot (125), the Rod Stop Slot (130), the Wall (135) of the Rod Stop Slot (130), the Rod Incline Rail (140) and the Rod Guide Rail (145), are either integrated into, or affixed to the Rod Receiver Side Plate (110).

In most embodiments, the Rod Receiver Side Plate (110) would be a strong grade of steel or other metal so as to provide its function with high reliability. The Rod Receiver Side Plate (110) could be lesser grades of steel, iron, less strong metals, or even wood or plastic, with the functional exchange being the amount of force to which the Rod Receiver Side Plate (110) would be subjected against the reliability and life of the Rod Receiver Back Plate (105).

The Rod Receiver Side Plate (110) may be integrally formed onto the Rod Receiver Back Plate (105) as part of the Rod Receiver (100). The Rod Receiver Side Plate (110) may be welded onto the Rod Receiver Back Plate (105) as part of the Rod Receiver (100). Other methods of attaching the Rod Receiver Side Plate (110) onto the Rod Receiver Back Plate (105) are possible.

On receiving the forces when the halves of the DROP PRESSURE RELEASE connect, the Rod Receiver Side Plate (110) partially absorbs the forces, and partially transmits the forces to the Rod Receiver Back Plate (105).

The at least one Rod Receptacle (115) receive and hold the at least one Rod of the Rod Holder (200) within the Rod Receiver (100). Each of the at least one Rod Receptacle (115) comprise multiple functional portions that together serve to guide the rods of the Rod Holder (200). Among these functional portions are the Receptacle Slot (125), the Rod Stop Slot (130), the Wall (135) of the Rod Stop Slot (130), the Rod Incline Rail (140), and the Rod Guide Rail (145).

In most embodiments, the at least one Rod Receptacle (115) would be a strong grade of steel or other metal so as to provide its function with high reliability. The at least one Rod Receptacle (115) could be lesser grades of steel, iron, less strong metals, or even wood or plastic, with the functional exchange being the amount of force to which the Rod Receiver (100) would be subjected against the reliability and life of the at least one Rod Receptacle (115).

The Receptacle Slot (125) is the entry point for the Rod Holder (200) of the DROP PRESSURE RELEASE to match together the Rod Receiver (100) with the Rod Holder (200). The Receptacle Slot (125) is sized with a dimension ‘d_{H}’ which must be sized allow a Rod to pass through as to allow the Rod Receiver (100) to receive the Rod Holder (200). Typically the Receptacle Slot (125) is slightly larger than the rods of the Rod Holder (200) to allow spacing for minor assembly alignment variations and fluctuations that occur in the manufacture of rods. Since in some embodiments, ‘d_{R}’ is approximately one inch, then ‘d_{H}’ is approximately larger than one inch. In some embodiments, ‘d_{H}’ is approximately 5 to 50 per cent larger than ‘d_{R}’.

The Outer Edge (120) of the Rod Receiver (100) has multiple functions. One function is to serve as the demarcation between each of the least one Rod Receptacle (115). Another function is to keep the Rod Holder (200) from bottoming on the Rod Receiver (100) and damaging the dock. Like the other structures of the Rod Receiver (100), the Outer Edge (120) could be a strong grade of steel or other metal so as to provide its function with high reliability. The Outer Edge (120) could be lesser grades of steel, iron, less strong metals, or even wood or plastic, with the functional exchange being the amount of force to which the Rod Receiver (100) would be subjected against the reliability and life of the Outer Edge (120).

Within each of the at least one Rod Receptacle (115) is a Rod Stop Slot (130) which adjacently below the Receptacle Slot (125). The Rod Stop Slot (130) has a vertical rise as to block movement of a laterally-oriented rod within the at least one Rod Receptacle (115). In most embodiments, the Rod Stop Slot (130) would be a strong grade of steel or other metal so as to provide its function with high reliability. The Rod Stop Slot (130) could be lesser grades of steel, iron, less strong metals, or even wood or plastic, with the functional exchange being the amount of force to which the Rod Receiver (100) would be subjected against the reliability and life of the Rod Stop Slot (130).

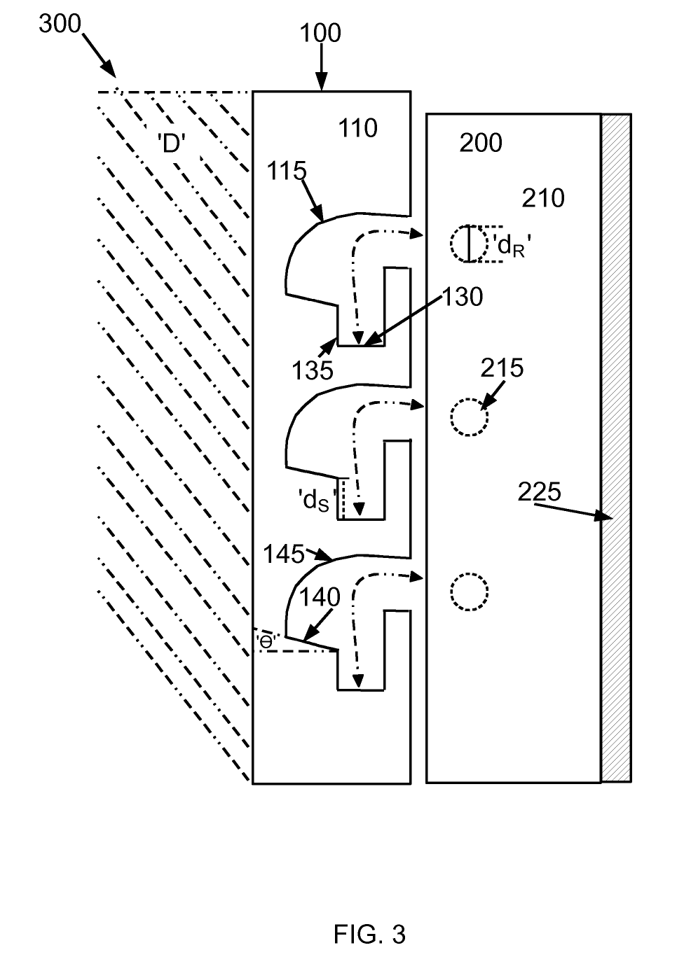

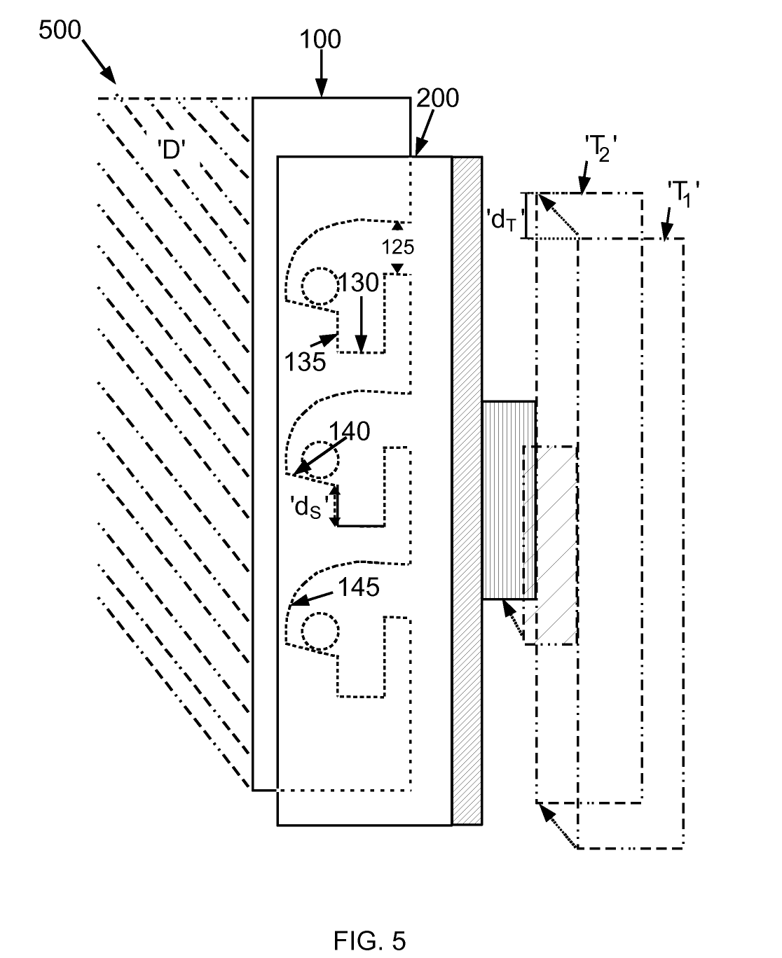

Within each of the Rod Stop Slot (130) is a Wall (135) which serves to hold a Rod of the Rod Holder (200) in place when the DROP PRESSURE RELEASE is not in use. An important aspect of the Wall (135) of the Rod Stop Slot (130) is that the Wall (135) has a dimension ‘d_{S}’ (see FIG. 3), which is approximately the same as the dimension ‘d_{H}’, but as discussed later, is less than the amount of travel when the door end of the trailer moves up and back, ‘d_{T}’ (see FIG. 5).

Within each of the at least one Rod Receptacle (115) is a Rod Incline Rail (140), which is adjacent to the Rod Stop Slot (130). From the position of the Rod Stop Slot (130), the Rod Incline Rail (140) is pitched upward toward the Rod Receiver Back Plate (105). When a tractor-trailer or large truck contacts the DROP PRESSURE RELEASE and presses the DROP PRESSURE RELEASE towards the dock, the Rod Incline Rail (140) directs the Rod Holder (200) upward and toward the Rod Receiver Back Plate (105).

In some embodiments, the Rod Incline Rail (140) has an incline angle (‘θ’) of approximately 10 to 40 degrees above horizontal. In some embodiments, the Rod Incline Rail (140) has a length of approximately twice the diameter of the at least one Rod (215), discussed below.

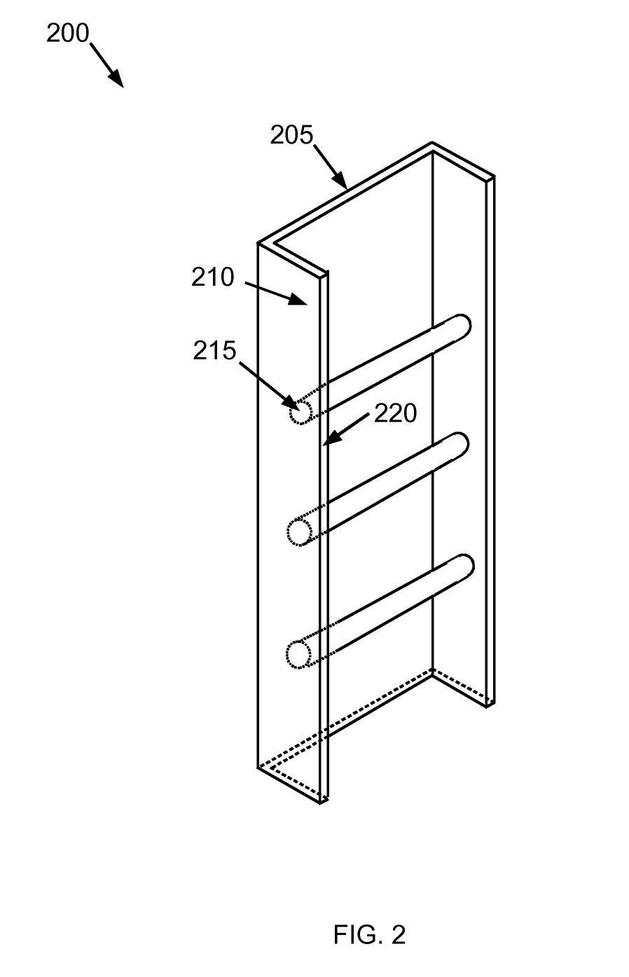

Within each of the at least one Rod Receptacle (115) is a Rod Guide Rail (145). The Rod Guide Rail (145) is between the Rod Incline Rail (140) and the Receptacle Slot (125). The Rod Guide Rail (145) guides the at least one Rod (215) (FIG. 2) in and out of the at least one Rod Receptacle (115) during installation and removal, and guides the at least one Rod (215) upwards away from the Rod Receiver Back Plate (105) to mitigate damage if a trailer travels upwards more than the height of the Rod Incline Rail (140).

In addition, the design of the Rod Guide Rail (145) makes for easy assembly and disassembly, allowing installation and maintenance with a small dock-crew. In some embodiments, the Rod Guide Rail (145) has a shape approximating a curve. In some embodiments, the Rod Guide Rail (145) has a shape with corners. In some embodiments, the Rod Guide Rail (145) has a length approximately three times the diameter of the at least one Rod (215), discussed below.

FIG. 2 shows an inside view of an exemplary Rod Holder (200) of the DROP PRESSURE RELEASE.

Shown in FIG. 2 is the Rod Holder (200), with a Rod Holder Back Plate (205), at least one Rod Holder Side Plate (210), at least one Rod (215), and an Outer Edge (220) of the Rod Holder Side Plate (210).

Unlike the Rod Receiver (100), which is affixed to a dock, the exemplary Rod Holder (200) is designed to rest freely on the Rod Receiver (100). In resting freely, the Rod Holder (200) is free to move when contacted by a tractor-trailer or truck.

The Rod Holder Back Plate (205) is the support structure for the Rod Receiver (100) in that the other components of the Rod Receiver (100) are affixed directly or indirectly to the Rod Holder Back Plate (205).

The Rod Holder Back Plate (205) is the also primary structure for the DROP PRESSURE RELEASE in that the Rod Holder Back Plate (205) receives the direct force of a tractor-trailer or truck that contacts the DROP PRESSURE RELEASE.

In most embodiments, the Rod Holder Back Plate (205) would be a strong grade of steel or other metal so as to provide its function with high reliability. The Rod Holder Back Plate (205) could be lesser grades of steel, iron, less strong metals, or even wood or plastic, with the functional exchange being the amount of force to which the DROP PRESSURE RELEASE would be subjected against the reliability and life of the Rod Holder Back Plate (205).

The at least one Rod Holder Side Plate (210) is affixed to the Rod Holder Back Plate (205) and serves as the support structure for other component of the Rod Holder (200).

In most embodiments, the at least one Rod Holder Side Plate (210) would be a strong grade of steel or other metal so as to provide its function with high reliability. The at least one Rod Holder Side Plate (210) could be lesser grades of steel, iron, less strong metals, or even wood or plastic, with the functional exchange being the amount of force to which the DROP PRESSURE RELEASE would be subjected against the reliability and life of the at least one Rod Holder Side Plate (210).

The at least one Rod Holder Side Plate (210) may be integrally formed onto the Rod Holder Back Plate (205) as part of the Rod Holder (200). The at least one Rod Holder Side Plate (210) may be welded onto the Rod Holder Back Plate (205) as part of the Rod Holder (200). Other methods of attaching the at least one Rod Holder Side Plate (210) onto the Rod Holder Back Plate (205) are possible.

Affixed to the at least one Rod Holder Side Plate (210) are at least one Rod (215).

The at least one Rod (215) may be integrally formed onto the at least one Rod Holder Side Plate (210) as part of the Rod Holder (200). The at least one Rod (215) may be welded onto the at least one Rod Holder Side Plate (210) as part of the Rod Holder (200). Other methods of attaching the at least one Rod (215) onto the at least one Rod Holder Side Plate (210) are possible.

In most embodiments, the at least one Rod (215) would be a strong grade of steel or other metal so as to provide its function with high reliability. The at least one Rod (215) could be lesser grades of steel, iron, less strong metals, or even wood or plastic, with the functional exchange being the amount of force to which the DROP PRESSURE RELEASE would be subjected against the reliability and life of the at least one Rod (215).

To assure that the Rod Holder (200) doesn't contact a dock during operation, the at least one Rod (215) is located adjacent to an Outer Edge (220) of the Rod Holder Side Plate (210) and affixed to the least one Rod Holder Side Plate (210) with each of the at least one Rod (215) having a diameter ‘d_{R}’. In some embodiments, each of the at least one Rod (215) has a diameter of approximately one inch.

FIG. 3 shows a side view of the exemplary Rod Receiver (100) mounted on a dock “D”, with the Rod Holder (200) aligned next to it, with arrows indicating how the Rod Holder (200) is set for placement within the Rod Receiver (100). Shown in FIG. 3 are the exemplary Rod Receiver (100) with its Rod Receiver Side Plate (110), the Rod Stop Slot (130) having a Wall (135) with a height ‘d_{S}’, Rod Incline Rail (140), and the Rod Guide Rail (145). Also shown in FIG. 3 are the exemplary Rod Holder (200) with its Rod Holder Side Plate (210) and the at least one Rod (215) having a diameter ‘d_{R}’. Also shown in FIG. 3 is Rod Holder Bumper (225).

As stated above, DROP PRESSURE RELEASE should be easy to manage with a small dock crew. As shown by FIG. 3, the Rod Holder (200) is placed in front of the Rod Receiver (100), and the at least one Rod (215) are aligned with the Receptacle Slot (125) of the at least one Rod Receptacle (115). The at least one Rod (215) are then placed into the at least one Rod Receptacle (115), and the Rod Holder (200) lowered until the at least one Rod (215) are resting beside the Rod Stop Slot (130).

The Rod Holder Bumper (225) is attached to the Rod Holder Back Plate (205) of the Rod Holder (200) but on a face away from the at least one Rod (215), so that the Rod Holder Bumper (225) is adjacent to any vehicle approaching the DROP PRESSURE RELEASE.

In this configuration, the Rod Holder Bumper (225) cushions the DROP PRESSURE RELEASE from a full impact from a trailer or other docking vehicle. The Rod Holder Bumper (225) may be made from any material, including rubber, wood, steel, iron, other natural materials, other natural elastic materials, recycled rubber, plastic, a composite of rubber and plastic, other artificial materials, or other artificial elastic materials.

The Rod Holder Bumper (225) may be any thickness, although the effectiveness of the Rod Holder Bumper (225) depends on both the material and the thickness. In some embodiments, the Rod Holder Bumper (225) may be recycled rubber with a thickness of approximately one and half inches.

The Rod Holder Bumper (225) may be attached to the Rod Holder Back Plate (205) by any method suitable of attaching a bumper. In some embodiments, one or more fasteners may be used to attach the Rod Holder Bumper (225) to the Rod Holder Back Plate (205). The one or more fasteners may be screws, bolts, clips, clamps, staples, rivets or other fasteners. In some embodiments, an adhesive may be used to attach the Rod Holder Bumper (225) to the Rod Holder Back Plate (205).

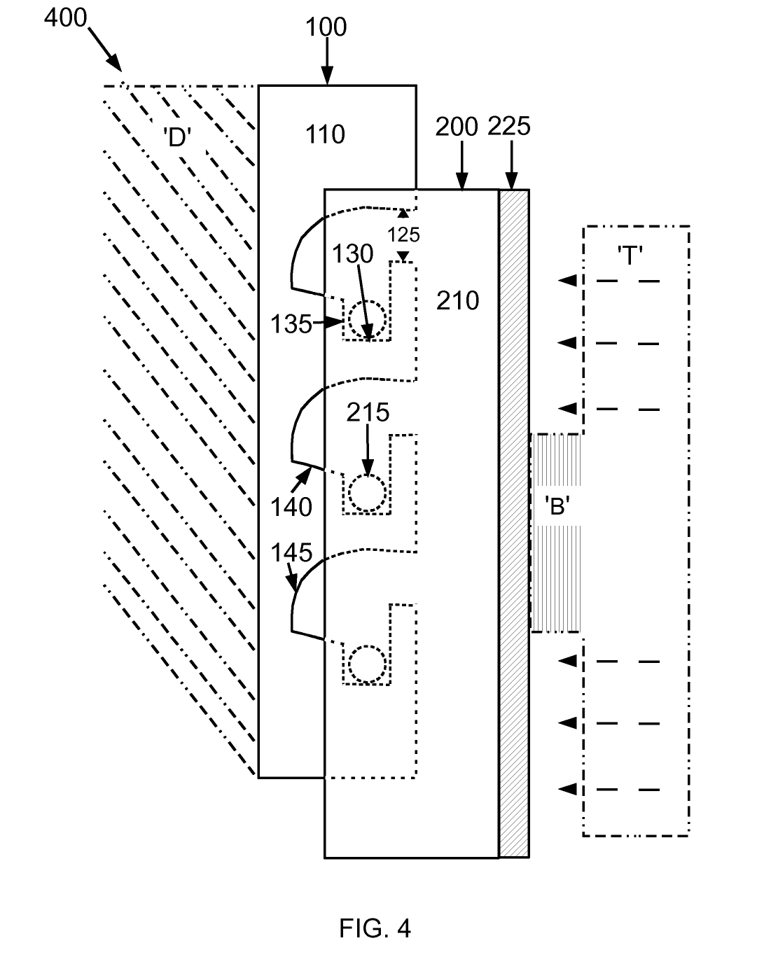

FIG. 4 shows the exemplary Rod Receiver (100) mounted on a dock ‘D’, with the Rod Holder (200) set onto the Rod Receiver (100). Shown in FIG. 4 is the Rod Receiver Side Plate (110), at least one Rod Receptacle (115), the Receptacle Slot (125), the Rod Stop Slot (130), the Wall (135) of the Rod Stop Slot (130), the Rod Incline Rail (140), and a Rod Guide Rail (145).

Also shown in FIG. 4 are the Rod Holder (200) with its Rod Holder Side Plate (210) and the at least one Rod (215), which as shown in FIG.3, has a diameter ‘d_{R}’. Also shown in FIG. 4 is the Rod Holder Bumper (225).

Also shown in FIG. 4 is a bumper (B’) of a tractor-trailer or truck (‘T’) with dashed lines showing the tractor-trailer or truck ‘T’ as having approached the DROP PRESSURE RELEASE. The tractor-trailer or truck ‘T’ is sufficiently close to contacting with the Rod Holder (200) portion of the DROP PRESSURE RELEASE that it would contact with the Rod Holder (200) portion of the DROP PRESSURE RELEASE when parked into position for unloading.

Dotted lines show hidden portions of the Rod Receiver (100), indicating that the sides of the at least one Rod Holder Side Plate (210) of the Rod Holder (200) are outside of the sides of the Rod Receiver Side Plate (110) of the Rod Receiver (100).

The significance of FIG. 4 will become apparent in contrasting the position of the Rod Holder (200) and the Truck ‘T’ with the Rod Receiver (100) in FIG. 5.

FIG. 5 shows the exemplary Rod Receiver (100) mounted on a dock ‘D’, with at least one Rod (215) of the Rod Holder (200) within the Rod Receiver (100), as well as the bumper (‘B’) of tractor-trailer or truck ‘T’ in positions ‘T_{1’} and ‘T₂’ adjacent to the DROP PRESSURE RELEASE. Position ‘T₁’ represents tractor-trailer or truck ‘T’ as shown in FIG. 4.

Position ‘T₂’ represents tractor-trailer or truck ‘T’ when parked into position for unloading. As shown in FIG. 5, the Rod Holder (200) has been pushed upwards and towards the dock. In allowing this movement, and the DROP PRESSURE RELEASE blocks the impact of the movement of tractor-trailer or truck ‘T’ on the dock during the parking process, and gives a clear indication that the tractor-trailer or large truck is in contact with the DROP PRESSURE RELEASE.

Also representative of this movement is dimension indicator ‘d_{T}’, which is the difference between positions ‘T₁’ and ‘T₂’. Just as the diameter ‘d_{R}’ (FIG. 3) of the at least one Rod (215) is related to the height ‘d_{H}’ (FIG. 1) of the Receptacle Slot (125), ‘d_{T}’, is correlated to the height ‘d_{S}’ of the Wall (135) to permit the Rod Holder (200) to move upwards and back. If for example, the change in position of the trailer is 2 inches, then ‘d_{S}’ must be able to accommodate a two inch position change. In some embodiments, ‘d_{S}’<‘d_{T}’ to provide assurance that the at least one Rod (215) of the Rod Holder (200) will rise out of the Rod Stop Slot (130).

When these relationships are true, then the at least one Rod (215) of the Rod Holder (200) will rise out of the Rod Stop Slot (130), and the at least one Rod (215) travels along the Rod Incline Rails (140). As shown by FIG. 5, the Rod Incline Rail (140) has an incline angle (‘θ’) which directs the at least one Rod (215) of the Rod Holder (200) upwards during the backwards travel of the Rod Holder (200) as trailer or truck ‘T’ pushes Rod Holder (200) upwards and backwards. This upwards and backwards movement helps prevent the Rod Holder (200) from striking the dock. In addition, when trailer ‘T’ is about to be re-attached to a tractor, the incline angle of the Rod Incline Rail (140) directs the at least one Rod (215) back into the Rod Stop Slot (130). In some embodiments, the Rod Incline Rail (140) has an incline angle (‘θ’) of approximately 10 to 40 degrees above horizontal.

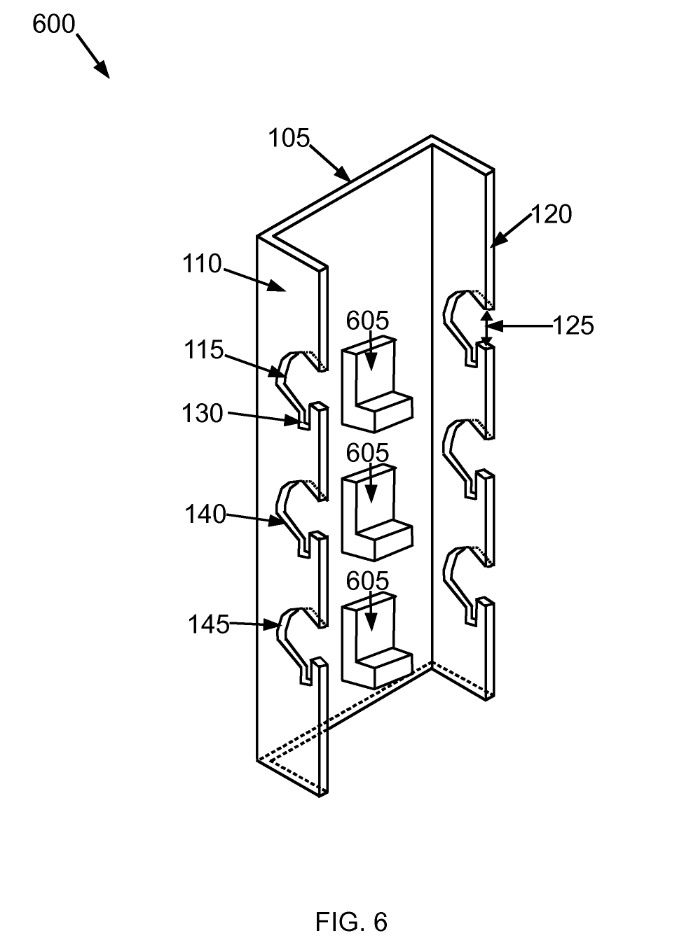

FIG. 6 shows an alternate embodiment of the Rod Receiver (600) of the DROP PRESSURE RELEASE. Shown in FIG. 6 are the Rod Receiver (600), which comprises the Rod Receiver Back Plate (105), the Rod Receiver Side Plate (110), the at least one Rod Receptacle (115), the Outer Edge (120) of the Rod Receiver Side Plate (110), the Receptacle Slot (125), the Rod Guide Rail (145), the Rod Incline Rail (140), the Rod Stop Slot (130), and at least one Midline Rod Shelf (605). The at least one Midline Rod Shelf (605) provides additional support to the at least one Rod Receptacle (115) when aligned to hold the at least one Rod of the Rod Holder (200). The at least one Midline Rod Shelf (605) may comprise a plurality of blocks. The at least one Midline Rod Shelf (605) may comprise a curved body similar on shape to the at least one Rod Receptacle (115).

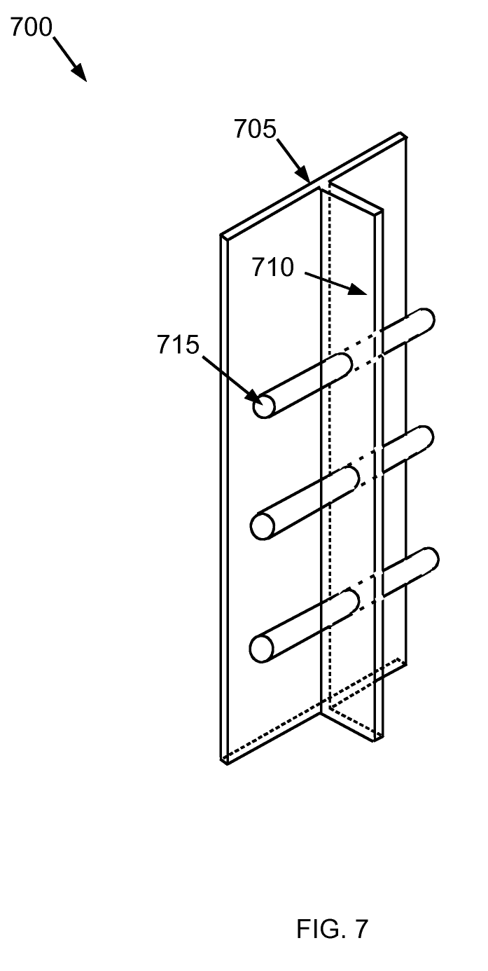

FIG. 7 shows an alternate embodiment of the Rod Holder (700) of the DROP PRESSURE RELEASE. Shown in FIG. 7 is the Rod Holder (700), with a Rod Holder Back Plate (705), one Rod Holder Midline Plate (710), and at least one Rod (715). The function and composition of the Rod Holder Back Plate (705), and the at least one Rod (715) are the same as for the exemplary Rod Holder (200) of the DROP PRESSURE RELEASE. The one Rod Holder Midline Plate (710) serves the same function as the Rod Holder Side Plate (210). Having one Rod Holder Midline Plate (710) is advantageous for weight concerns and may be used when high contact forces are unlikely to be present.

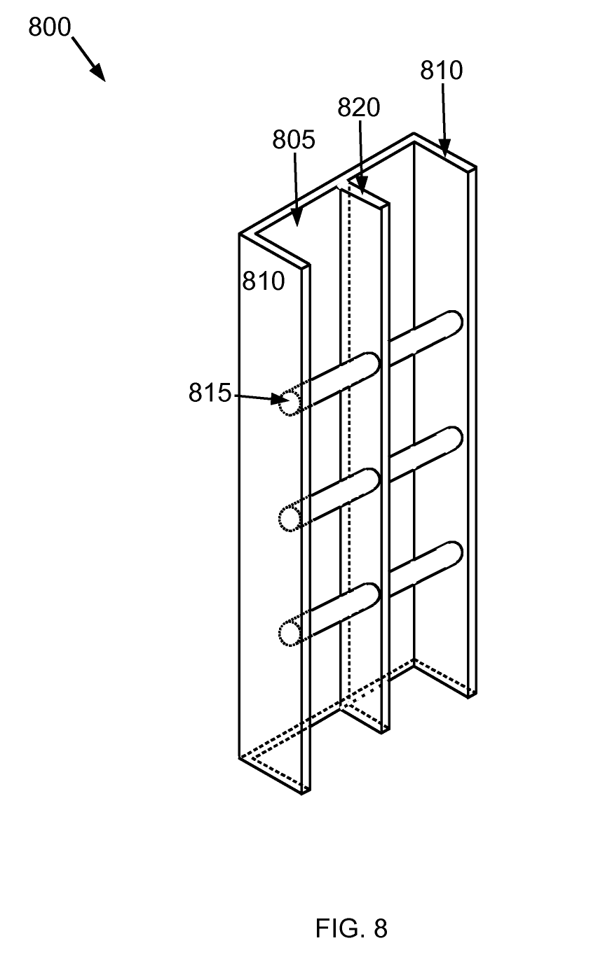

FIG. 8 shows an alternate embodiment of the Rod Holder (800) of the DROP PRESSURE RELEASE. Shown in FIG. 8 are the Rod Holder (800), with a Rod Holder Back Plate (805), two Rod Holder Side Plates (810), and at least one Rod (815), and a Midline Rod Holder Stabilizer (820). The Rod Holder (800) is essentially a composite of the Rod Holder (200) and the Rod Holder (700). The function of the Rod Holder (800) and its components are the same as for the Rod Holder (200) and the Rod Holder (700) of the DROP PRESSURE RELEASE. Having two Rod Holder Side Plates (810), and a Midline Rod Holder Stabilizer (820) is advantageous when high contact forces are likely to be present.

These descriptions and drawings are embodiments and teachings of the disclosure. All variations are within the spirit and scope of the disclosure. This disclosure is not to be considered as limiting the claims to only the embodiments illustrated or discussed. Certain changes can be made in the subject matter without departing from the spirit and the scope of this disclosure. It is realized that changes are possible within the scope of this disclosure. It is intended that each structure or element recited in any of the claims is to be understood as referring to all equivalent structure or elements. The following claims are intended to cover the disclosure as broadly as possible in whatever form it may be used.

What is claimed is:

1) A Rod Receiver comprising
a Rod Receiver Back Plate, with
at least one Rod Receiver Side Plate affixed to the Rod Receiver Back Plate, with
at least one Rod Receptacle within the Rod Receiver Side Plate, with
a Receptacle Slot having a height ‘d_{H}’ within each of the at least one Rod Receptacle and located along an Outer Edge of the at least one Rod Receiver Side Plate, with
a Rod Stop Slot adjacently below the Receptacle Slot and having a Wall with a height ‘d_{S}’ with
a Rod Incline Rail adjacent to the Rod Stop Slot and having an incline angle (‘θ’) within each of the at least one Rod Receptacle, and
a Rod Guide Rail within each of the at least one Rod Receptacle and having a shape approximating a curve between the Rod Incline Rail and the Receptacle Slot.

2) A Rod Holder comprising
a Rod Holder Back Plate, with
at least one Rod Holder Side Plate affixed to the Rod Holder Back Plate,
at least one Rod located adjacent to an Outer Edge of the Rod Holder Side Plate and affixed to the least one Rod Holder Side Plate with each of the at least one Rod having a diameter ‘d_{R}’.

3) An apparatus for protecting a dock comprising
a Rod Receiver having a at least one Rod Receptacle with each of the at least one Rod Receptacle having a Receptacle Slot having a height ‘d_{H}’ with a Rod Stop Slot adjacently below the Receptacle Slot and having a Wall with a height ‘d_{S}’ between the Rod Stop Slot and a Rod Incline Rail, and
a Rod Holder having at least one Rod with the at least one Rod having a diameter ‘d_{R}’ which is less than the Receptacle Slot height ‘d_{H}’.

4) The Rod Receiver of claim 1 wherein the height ‘d_{S}’ is less than the height ‘d_{H}’ within each of the at least one Rod Receptacle.

5) The Rod Receiver of claim 1 wherein the incline angle (‘θ’) of the Rod Incline Rail is approximately 10 to 40 degrees above horizontal.

6) The Rod Receiver of claim 1 further comprising a Midline Rod Shelf.

7) The Rod Receiver of claim 1 wherein the Rod Receiver comprises a material selected from the group consisting of steel, iron, wood and plastic.

8) The Rod Receiver of claim 1 wherein the Rod Guide Rail has a shape approximating a curve.

9) The Rod Receiver of claim 1 wherein the Rod Guide Rail has a shape with corners.

10) The Rod Holder of claim 2 wherein each of the at least one Rod has a diameter of approximately one inch.

11) The Rod Holder of claim 2 further comprising a Midline Rod Holder Stabilizer.

12) The Rod Holder of claim 2 further comprising an Rod Holder Bumper which comprises a material selected from the group consisting of rubber, recycled rubber, wood, plastic, steel, iron, and a composite of rubber and plastic.

13) The Rod Holder of claim 2 further comprising an Rod Holder Bumper having with a thickness of approximately one and half inches.

14) The Rod Holder of claim 2 further comprising an Rod Holder Bumper which comprises a material selected from the group consisting of natural materials, elastic materials, and artificial material.

15) The Rod Holder of claim 2 wherein the Rod Holder comprises a material selected from the group consisting of steel, iron, wood and plastic.

16) The apparatus of claim 3 wherein the height ‘d_{S}’ of the Rod Stop Slot is less than the Receptacle Slot height ‘d_{H}’.

17) The apparatus of claim 3 wherein the at least one Rod is affixed to at least one Rod Holder Side Plate.

18) The apparatus of claim 3 wherein the at least one Rod is affixed to a Rod Holder Midline Plate.

19) The apparatus of claim 3 wherein the diameter ‘d_{R}’ of the at least one Rod is less than the Receptacle Slot height ‘d_{H}’.

20) The apparatus of claim 3 wherein the diameter ‘d_{R}’ of the at least one Rod is approximately equal to the Wall height ‘d_{S}’.

21) The apparatus of claim 3 wherein the diameter ‘d_{R}’ of the with the at least one Rod is greater than the Wall height ‘d_{S}’.
